(19) United States
(12) Patent Application Publication
(10) Pub. No.: US 2013/0017405 A1
(43) Pub. Date: Jan. 17, 2013

(54) Self-Healing Coatings

(71) Applicants: Jason J. Benkoski, Ellicott City, MD (US); Rengaswamy Srinivasan, Ellicott City, MD (US); Jeffrey P. Maranchi, Clarksburg, MD (US)

(72) Inventors: Jason J. Benkoski, Ellicott City, MD (US); Rengaswamy Srinivasan, Ellicott City, MD (US); Jeffrey P. Maranchi, Clarksburg, MD (US)

(73) Assignee: THE JOHNS HOPKINS UNIVERSITY, Baltimore, MD (US)

(21) Appl. No.: 13/593,047

(22) Filed: Aug. 23, 2012

Related U.S. Application Data
(63) Continuation-in-part of application No. 13/083,819, filed on Apr. 11, 2011.
(60) Provisional application No. 61/349,352, filed on May 28, 2010.

(51) Int. Cl. H01B 1/22; B32B 15/02

(52) U.S. Cl. 428/562; 428/560; 252/512

(57) ABSTRACT

A microcapsule is disposed in a self-healing coating having zinc powder particles dispersed therein. The microcapsule includes at least a silane coupling agent encapsulated within a volume defined by a metallic or polymeric shell that is rupturable responsive to formation of a fissure in the self-healing coating.

### CROSS-REFERENCE TO RELATED APPLICATIONS

This application is a continuation-in-part of application Ser. No. 13/083,819, filed Apr. 11, 2011, which claims the benefit of prior filed U.S. Provisional Application No. 61/349,352, filed May 28, 2010, the contents of each of which are incorporated herein in their entireties.

### BACKGROUND

The present disclosure generally relates to a self-healing coating using metallic microcapsules.

The cost of corrosion is estimated to be at least $276 billion per year in the U.S. alone. A 2001 study commissioned by the Federal Highway Administration analyzed 26 industrial sectors to find that direct costs accounted for approximately 3.2% of the U. S. economy. Often overlooked in these numbers are the costs related to equipment downtime. For example, the time spent replacing or rehabilitating corroded equipment not only ties up valuable manpower, but also makes it necessary to maintain a reserve of excess capital equipment. With service rotations as short as 6 months, even a modest increase in service life can lead to significant savings.

The most common approach to preventing corrosion is to paint the surface with a protective coating. Typically, paints composed of an inorganic powder embedded within a polymer matrix have only limited ability to resist abrasion. Attempts to improve durability are ultimately constrained by the requirements that the coating be relatively thin (e.g., <100 μm) and easy to apply. While repainting and touch-ups can be performed as part of regular maintenance, many defects go unnoticed before significant damage occurs. Accordingly, self-healing coatings have been developed that autonomously repair scratches below some maximum width, thereby delaying the onset of corrosion and increasing the time between maintenance cycles.

The most common strategies utilized in developing self-healing polymer coatings are to supply energy to the system to form new bonds, or supply additional material to the damage zone. Supplying energy to the system could be as simple as heating a polymeric coating to achieve melt and reflow. Other examples include the use of heat to activate a reversible Diehls-Alder reaction, applying UV light to initiate the polymerization of pendant vinyl groups, and the use of hydrogen bonded polymers near their effective melting temperature. The advantage of energy activation is the potential for unlimited healing capacity. However, heating is logistically impractical for large objects, and UV activation may not provide complete healing if pigments in the coating interfere with light absorption.

Another approach achieves self-healing by supplying additional material to the damage zone. For example, one technique for delivering a reservoir of fresh material to a scratch include the use of embedded polymer microcapsules incorporated into paints and primers. The microcapsules release the self-healing compound or compounds, most commonly as liquids, when the coating system is damaged. However, appropriate materials should be used to fabricate the microcapsule and its contents, else it may “deploy” before the coating is applied or, upon application, spontaneously deploy improperly, i.e., without a physical compromise of the coating such as abrasion or nicking. Further, unless the microcapsule is compatible with both its contents (the encapsulated repair compound) and its surrounds (the solvent), the “application” life of the resultant mixed product may be less than desirable.

Accordingly, there is a continued need for improved self-healing coatings that can be made in a simple, cost efficient manner.

### SUMMARY

In accordance with one example embodiment, there is provided a microcapsule disposed in a self-healing coating in addition to zinc particles that are also dispersed within the coating. The microcapsule includes at least a silane coupling agent encapsulated within a volume defined by a polymeric or metallic shell that is rupturable responsive to formation of a fissure in the self-healing coating.

In accordance with another example embodiment, there is provided a self-healing coating composition including one or more film-forming binders, a plurality of microcapsules, and zinc powder particles. The microcapsules may include at least a silane coupling agent encapsulated within a volume defined by a polymeric or metallic shell that is rupturable responsive to formation of a fissure in the self-healing coating.

In accordance with another example embodiment, there is provided a coated article. The coated article may include a metal substrate and a self-healing coating adjacent the substrate. The self-healing coating may include a plurality of microcapsules and zinc powder particles. The microcapsules may include at least a silane coupling agent encapsulated within a volume defined by a polymeric or metallic shell that is rupturable responsive to formation of a fissure in the self-healing coating.

The polymeric or metallic microcapsules of some example embodiments may be particularly suitable for adding to one or more film-forming binders to form a self-healing coating composition to be cured at ambient temperature to facilitate self-healing of the resultant coating after being damaged. For example, when the applied self-healing coating is damaged, e.g., by abrasion through the coating to the substrate on which it is applied, the metallic microcapsules burst, thereby releasing the silane coupling agent disposed therein. This initiates a self-healing process, i.e., the damaged area of the substrate is covered and repaired. This provides a “self-healing” ability to the coating which protects the substrate even after the coating is damaged. Further, when the silane coupling agent is released, the silane coupling agent will spontaneously wet the freshly exposed substrate and fill the crack or fissure to form a monolayer. The ability to protect the substrate with as little as a molecular monolayer allows the silane coupling agent to heal a larger scratch for a given volume of released silane coupling agent.

In addition to the self-healing properties, the self-healing coating also provides galvanic protection, which is provided by the metallic shell of the metallic microcapsule or zinc powder particles disposed in a matrix with a plurality of microcapsules. For example, while the silane monolayer is setting up, the zinc powder can act as a sacrificial anode to galvanically protect an exposed metal substrate, e.g., steel. The protection of the substrate at short times is critical to the formation of a protective silane or polymer film, because neither silanes nor polymers will form a continuous film upon rust. Therefore, since most metallic surfaces begin rusting immediately after they are scratched, self-repair is almost impossible without the assistance of galvanic protection while the protective barrier layer is being restored. The addition of the metallic zinc filler also provides strength and stiffness to the coating to compensate for the loss of mechanical properties caused by entrained resin.

### BRIEF DESCRIPTION OF THE DRAWINGS

The various features and advantages of example embodiments of this invention will become apparent to those skilled in the art from the following detailed description of the currently preferred embodiment. The drawings that accompany the detailed description can be briefly described as follows:

FIG. 1 is a general sectional view of a coated article having a coating according to an example embodiment of the present invention;

FIG. 2 is a general sectional view of a coated article according to the present invention while being flexed;

FIG. 3 shows test results according to an example embodiment;

FIG. 4, which includes FIGS. 4A, 4B and 4C, and illustrates a cross section view of monolayer formation in fissures of varying sizes according to an example embodiment;

FIG. 5 shows an example of a monolayer being formed over steel responsive to self-assembly of silanes according to an example embodiment; and

FIG. 6 illustrates a cross section view of a portion of a self-healing coating according to another example embodiment.

### DETAILED DESCRIPTION

One aspect of the present invention is directed to microcapsules including a polymeric microcapsule containing one or more polymeric precursors and optional water-immiscible composition comprising a substantially water-immiscible luminescent or colorimetric material encapsulated therein; and a polymeric shell enclosing a volume containing the self-healing fluids. The microcapsules are particularly suitable for adding to a liquid self-healing coating composition to be cured at ambient temperature to facilitate self-healing of the resultant self-healing coating after its application to a substrate and subsequent curing thereon, wherein damage to the self-healing coating results in rupture of the microcapsule and deployment of the one or more polymeric precursors and optional water-immiscible composition comprising a substantially water-immiscible luminescent or colorimetric material to fill and seal the compromised volume within the coating adjacent to the metallic microcapsule.

In general, the microcapsule can be formed employing conventional microcapsulating methods. In one preferred embodiment, the microcapsule is produced from an oil-in-water emulsion which contains one or more polymeric precursors, then causing interfacial polymerization to occur, so as to form microcapsules with a liquid interior (i.e., the one or more polymeric precursors and optional substantially water-immiscible luminescent or colorimetric material) and thin polymer shell, i.e., a polymeric microcapsule. In the interfacial polymerization method, an oil phase containing a polymer-forming resin is mixed with an aqueous phase in which a water-soluble polymer is dissolved in water followed by emulsifying and dispersing by means such as a homogenizer followed by adding one or more crosslinking agents, thereby a polymer forming reaction is caused at an oil/water interface, whereby a microcapsule wall made of the polymer-forming resin is formed. In the interfacial polymerization method, microcapsules having uniform particle diameters can be formed in a relatively short time period.

The oil phase is prepared from a mixture of one or more polymer-forming resins and optional water-immiscible composition comprising a substantially water-immiscible luminescent or colorimetric material. Suitable polymer-forming resins include any polymer-forming resins known in the art for making microcapsules. Representative examples of a polymer-forming resin include one or more of polyvalent isocyanate compounds. Representative examples of polyvalent isocyanate compounds include isocyanates such as isophorone diisocyanate, m-phenylenediisocyanate, p-phenylenediisocyanate, 2,6-tolylenediisocyanate, 2,4-tolylenediisocyanate, naphthalene-1,4-diisocyanate, diphenylmethane-4,4′-diisocyanate, 3,3′-diphenylmethane-4,4′-diisocyanate, xylene-1,4-diisocyanate, 4,4′-diphenylpropanediisocyanate, trimethylenediisocyanate, hexamethylenediisocyanate, propylene-1,2-diisocyanate, butylene-1,2-diisocyaate, cyclohexylene-1,2-diisocyanate, and cyclohexylene-1,4-diisocyanate; triisocyanates such as 4,4′,4″-triphenylmethanetriisocyanate, and toluene-2,4,6-triisocyanate; tetraisocyanates such as 4,4′-dimethylphenylmethane-2,2′, and 5,5′-tetraisocyanate; and isocyanate prepolymers such as poly[(phenyl isocyanate)-co-formaldehyde], an adduct of hexanemethylenediisocyanate and trimethylolpropane, an adduct of 2,4-tolylenediisocyanate and trimethylolpropane, an adduct of xylene diisocyanate and trimethylolpropane, and an adduct of tolylene diisocyanate and hexanetriol, and the like. If desired, two or more compounds can be used together as necessary.

If necessary, the oil phase can contain one or more additional additives such as dispersants, surfactants and the like and mixtures thereof. Examples of dispersants include water-insoluble pigment dispersants such as a copolymer with acidic groups marketed by Byk Chemie under the trade name DISPERBYK® 110, and a high molecular weight block copolymer with pigment affinic groups, marketed by Byk Chemie under the trade name DISPERBYK® 163 and the like. Examples of surfactants include Air Products DABCO® DC197 silicone-based surfactant and the like.

A suitable water-immiscible composition comprising a substantially water-immiscible luminescent or colorimetric material for encapsulation in the microcapsule includes any luminescent or colorimetric material known in the art. Representative examples of such luminescent or colorimetric material are Nile red, Nile blue, rhodamine, fluorescein, 9,10-diphenylanthracene, rubrene, tetracene, 9,10-bis(phenylethynyl)anthracene, and the like and mixtures thereof. In one embodiment, the substantially water-immiscible luminescent or colorimetric material is mixed with the one or more polymeric precursors (i.e., polymerizable monomers) to obtain a water-immiscible composition.

In general, the concentration of the polymer forming resin contained in the oil phase can range from about 50 to about 100 wt. %, based on the total weight of the oil solution.

The aqueous phase in which the oil phase is emulsified and dispersed will contain water and a surface active water-soluble polymer. Suitable surface active water-soluble polymer compounds include polyvinyl alcohol and its modified substances, polyacrylic acid amide and its derivatives, ethylene-vinyl acetate copolymer, styrene-maleic anhydride copolymer, ethylene-maleic anhydride copolymer, isobutylene-maleic anhydride copolymer, polyvinylpyrolidone, ethylene-acrylic copolymer, vinyl acetate-acrylic copolymer, carboxyl methyl cellulose, methyl cellulose, casein, gelatin, starch derivatives, gum arabic, sodium alginate, and the like. In one preferred embodiment, the water-soluble high polymers do not react with isocyanate compounds or have a relatively low reactivity therewith. For example, like gelatin, a water-soluble high polymer compound having a reactive amino group in the molecular chain thereof must be previously made nonreactive.

In general, the concentration of the water-soluble high polymer compound contained in the aqueous phase can range from about 0.1 to about 10 wt. %, based on the total weight of the aqueous solution.

As discussed hereinabove, the microcapsule is obtained by (a) forming an oil solution from (i) one or more polymer-forming resins, and optionally (ii) a water-immiscible composition comprising a substantially water-immiscible luminescent or colorimetric material to obtain an oil solution; (b) adding to the oil solution an aqueous solution containing a water-soluble polymer and forming an oil-in-water emulsion, e.g., by means of a homogenizer or the like; (c) adding one or more crosslinking agents to the emulsion; and (d) reacting the one or more polymer-forming resins and the one or more crosslinking agents, thereby producing a plurality of microcapsules having a capsule wall, with at least a major portion of one or more polymeric precursors and optional water-immiscible composition comprising a substantially water-immiscible luminescent or colorimetric material encapsulated within the capsule wall of the microcapsules. In general, the encapsulating may be carried out without using an organic solvent.

In one embodiment, the one or more polymeric precursors are unreacted polymer-forming resins. In other words, in reacting the one or more polymer-forming resins and the one or more crosslinking agents, an excess of the one or more polymer-forming resins is employed to provide unreacted polymer-forming resin(s), i.e., the one or more polymeric precursors, encapsulated in the microcapsule. In another embodiment, the one or more polymeric precursors are different than the polymer-forming resin(s). In this embodiment, one or more polymeric precursors are added to the emulsion and then encapsulated in the resulting microcapsule. Suitable polymeric precursors include by way of example, acrylate monomers, methacrylate monomers, vinyl pyridine monomers, vinyl ether monomers, acrylamide monomers, methacrylamide monomers, pyrrolidone monomers, styrene monomers, nylon monomers, polyamines, e.g., those obtained from the reaction of an acid chloride with amine, isocyanates such as isocyanates, diisocyanates and triisocyanates and the like and mixtures thereof.

Useful cross-linking agents include, but are not limited to, amines, alcohols and the like and mixtures thereof. Suitable amines as cross-linking agents include aliphatic and cycloaliphatic primary and secondary diamines and polyamines. Representative examples of such amines include 1,2-diaminoethane, diethylenetriamine, triethylenetetramine, bis-(3-aminopropyl)-amine, bis-(2-methylaminoethyl)methylamine, 1,4-diaminocyclohexane, 3-amino-1-methylaminopropane, N-methyl-bis-(3-aminopropyl)amine, 1,4-diamino-n-butane, 1,6-diamino-n-hexane, polyethylenimine, guanidine carbonate and the like and mixtures thereof. Suitable alcohols as cross-linking agents include primary or secondary aliphatic dialcohols or polyalcohols. Representative examples of such alcohols include ethanediol, 1,2-propanediol, 1,3-propanediol, 1,4-butanediol, 1,5-pentanediol, 1,6-hexanediol, glycerol, diethylene glycol, poly(vinyl alcohol), and the like and mixtures thereof. Also useful as cross-linking agents include aliphatic aminoalcohols such as, for example, triethanolamine.

If desired, a catalyst to harden the polymer precursor when exposed to moisture during rupture of the metallic microcapsule may be encapsulated in the microcapsule. The catalyst may be, for example, dibutyltin diacetate, 1,8-diazabicyclo[5.4.0]undec-7-ene, or a combination thereof.

The polymeric microcapsules (primary shells) will typically have an average diameter of about 1 to about 100 μm. In one embodiment, the shells of the polymeric microcapsules can have an average thickness of about 0.5 to about 10 μm. The microcapsules can be of any shape, e.g., spherical, circular and the like. However, other shapes, such as filaments, may be used also, with a concomitant loss of efficiency. In one embodiment, the polymeric microcapsule is rod shaped and will have an average diameter of about 1 to about 100 μm, and a macroscopic length greater than about 1 mm.

The microcapsules can have an overall average diameter of from about 1 to about 120 μm. In one embodiment, the metallic microcapsules can have an overall average diameter of from about 25 to about 50 μm. As discussed above, the microcapsules can be of any shape, e.g., spherical, circular, rod shaped and the like. However, other shapes, such as filaments, may be used also, with a concomitant loss of efficiency.

The foregoing microcapsules are added to one or more film forming binders to form a liquid self-healing coating composition. The term “film forming binder” means a nonencapsulated constituent of the liquid self-healing coating composition which holds other parts of the composition in a continuous layer after application to a selected surface of a substrate. The film-forming binders may be liquid or solid, depending on the particular application. The one or more film-forming binders may comprise a protective coating that would serve the purpose of protecting a substrate but not have the self-healing properties of the coating of an example embodiment of the present invention. This non-self healing protective coating composition may be one of a number of commercially available products such as, for example, primer paints, topcoat paints, “one coat” or “self-priming” paints, varnishes, lacquers, polyurethane finishes, shellacs, waxes, polishes, “one step” finishing preparations for wood, metal, or synthetic materials, and the like and combinations thereof. Suitable paint primers include polyurethanes, oil-based enamels, enamel undercoater, latex acrylics, acrylic formulations, epoxy formulations and the like. Suitable topcoat and self-priming paints include polyurethanes, oil-based enamels, enamels, latex acrylics, acrylic formulations, epoxy formulations and the like.

If desired, the self-healing coating composition can contain various additives known in the art. Representative examples of such additives include corrosion inhibitors, flow enhancing agents, and the like and mixtures thereof.

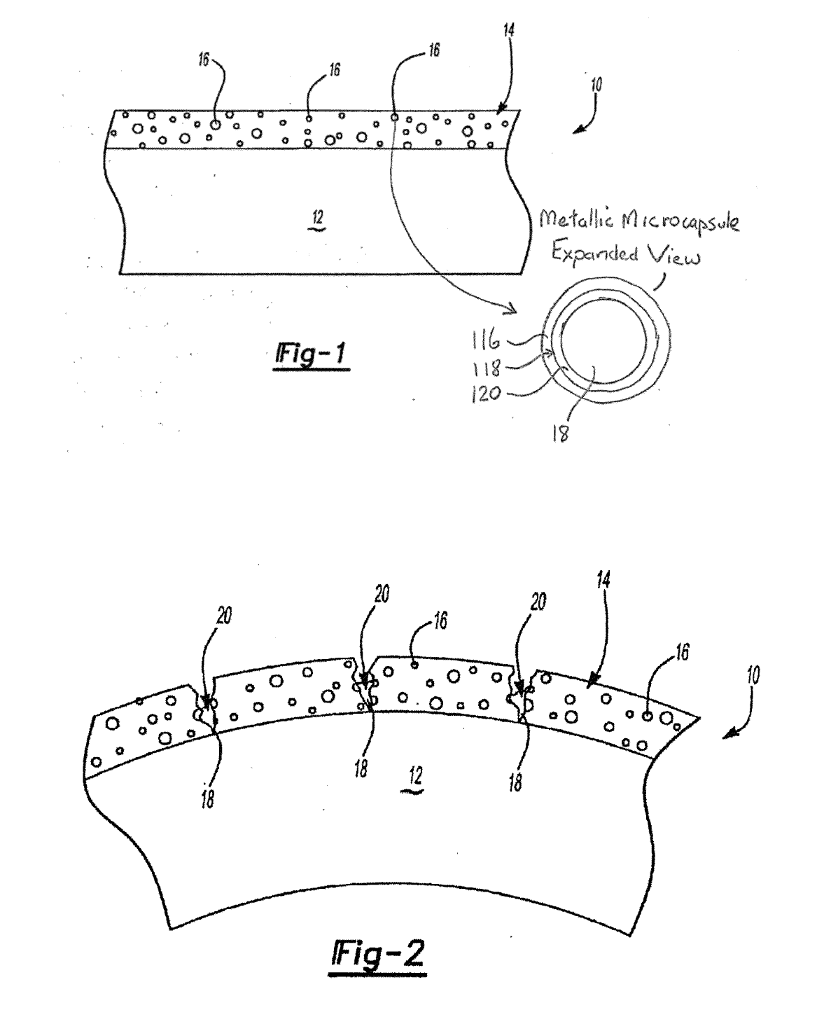

FIG. 1 illustrates a coated article 10 according to an example embodiment of the present invention. The article 10 generally includes a substrate 12 and a coating 14 having metallic microcapsules 16. In one embodiment, substrate 12 is a metal part. In one embodiment, a suitable metal substrate 12 is representative of a vehicle such as a humvee, truck, tank and the like, or a vehicle component such as a spring or suspension component which is typically subjected to a high corrosion environment. In another embodiment, a suitable metal substrate 12 is a bridge. The type of substrate 12, such as a metal substrate or the form in which it is provided for treatment in accordance with an example embodiment of the invention, is not limited within this invention.

The coating 14 is typically a paint or undercoating. The coating 14 is applied to the substrate 12 by conventional processes such as spraying or dipping. The coating 14 contains a sufficient quantity of the metallic microcapsules 16. However, it should be appreciated that in some embodiments polymeric microcapsules may be substituted for the metallic microcapsules 16. Thus, although this example may refer to microcapsules as being metallic, it should be appreciated that the metallic microcapsules 16 are one example of a microcapsule that may be used with an example embodiment, and other embodiments may employ polymeric microcapsules. Although a single coating is illustrated it will be understood that a multiple of coating 14 layers are contemplated.

The metallic microcapsules 16 are manufactured to contain the polymeric precursor 18 in a fluid state. The metallic microcapsules 16 are retained in the coating 14 to form a matrix of hardened coating 14 and metallic microcapsules 16. If desired, a mix of different metallic microcapsules 16 can be incorporated into coating 14 such that a multiple of properties can be incorporated directly into the coating 14.

Referring to FIG. 2, article 10 is shown in a flexed condition. Continual flexing of the coating article 10 may cause the coating to crack and form fissures 20 which can extend to the substrate 12. These fissures 20 may also be caused in a more immediate fashion by direct contact with an object that causes a scratch or break in the coating 14. Typically such a crack exposes the substrate 12 and leaves the substrate 12 unprotected against the environment and resulting corrosion.

According to an example embodiment of the present invention, however, the cracking of the coating 14 also breaks open the microcapsules 16 adjacent the fissure 20. The broken microcapsules 16 release the polymeric precursor 18 contained therein. Because the microcapsules 16 release the polymeric precursor 18 in the fluid state the polymeric precursor 18 flows into the fissure 20 and fills the exposed substrate 12. This provides a “self-healing” ability to the coating which protects the substrate 12 even after the coating 14 is damaged.

An example embodiment of the present invention therefore provides a self-healing coating which may increase the anti-corrosion protection of a metal substrate while maintaining a relatively inexpensive coating application process commonly practiced in the art. The following examples are provided to enable one skilled in the art to practice the invention and are merely illustrative of the invention. The examples should not be read as limiting the scope of the invention as defined in the claims.

In the examples, the following abbreviations are used.

IPDI=isophorone diisocyanate

PPI=polyphenylene isocyanate, Mn 400 g/mol

MIL-P=purified resin of MIL-P-26915 zinc-filled primer

DETA=diethylenetriamine

PEI=polyethylenimine, Mw 750,000 g/mol, 50% solids

PAA Solution=poly(acrylic acid), M_{w} 100,000 g/mol, 35% solids

I. Preparation of Microcapsules

Gum Arabic Solution: 50 g Gum Arabic was mixed with 292 g NaCl into 1 L of MilliQ water to give a 5% Gum Arabic 5 M NaCl solution.

Polyurethane Resin: 0.001 g Nile Red was mixed with 13 g IPDI, 2 g PPI, 2 g DABCO® DC197, 2 g DISPERBYK® 110, and 1 g MIL-P into a 50 mL beaker. The mixture was stirred and sonicated until uniform (65% IPDI, 10% PPI, 5% MIL-P, 10% DABCO® DC197, 10% DISPERBYK® 110, 0.005% Nile Red).

Crosslinker 1: 3 g of DETA was mixed with 17 g of 0.1 g/ml Gum Arabic solution and 5 M NaCl until uniform (15% DETA).

Crosslinker 2: 2 mL of 50 wt % PEI was mixed in 98 mL of MilliQ water to give a 1% solution of high molecular weight PEI.

Emulsion: 80 g Gum Arabic solution was poured in 5 M NaCl and 20 g Polyurethane Resin in a 250 mL Erlenmeyer flask at 70° C., then stirred at 1000 RPM with an IKA mechanical stirrer.

The Crosslinker 1 was poured into the emulsion, and stirring was continued at room temperature and 1000 RPM for 20 minutes to obtain microcapsules.

The microcapsules were purified by washing twice with MilliQ water and then 100 mL of the Crosslinker 2 solution was added with PEI. The solution was allowed to sit overnight while the PEI and water slowly reacted to form a hard outer shell.

II. Coating Composition

A coating composition was prepared by adding 1 part of the thus obtained metallic microcapsules to 3 parts of MIL-P-26915 primer resin in which all filler was removed from the primer.

III. ASTM B117 Salt Fog Test

A 3×6 steel substrate was coated with the coating composition until a thickness of 150 μm was achieved. Next, scratches of 1/64″ were made to the panels. The scratched panels were then tested in a salt fog chamber for 6 weeks according to ASTM B117. The panels were then removed from the water and evaluated for rust. A rust score was given by visual inspection according to the following:

0=100% rust across scratch, worst performance

1=75% rust across scratch

2=50%

3=25%

4=no rust, best possible performance

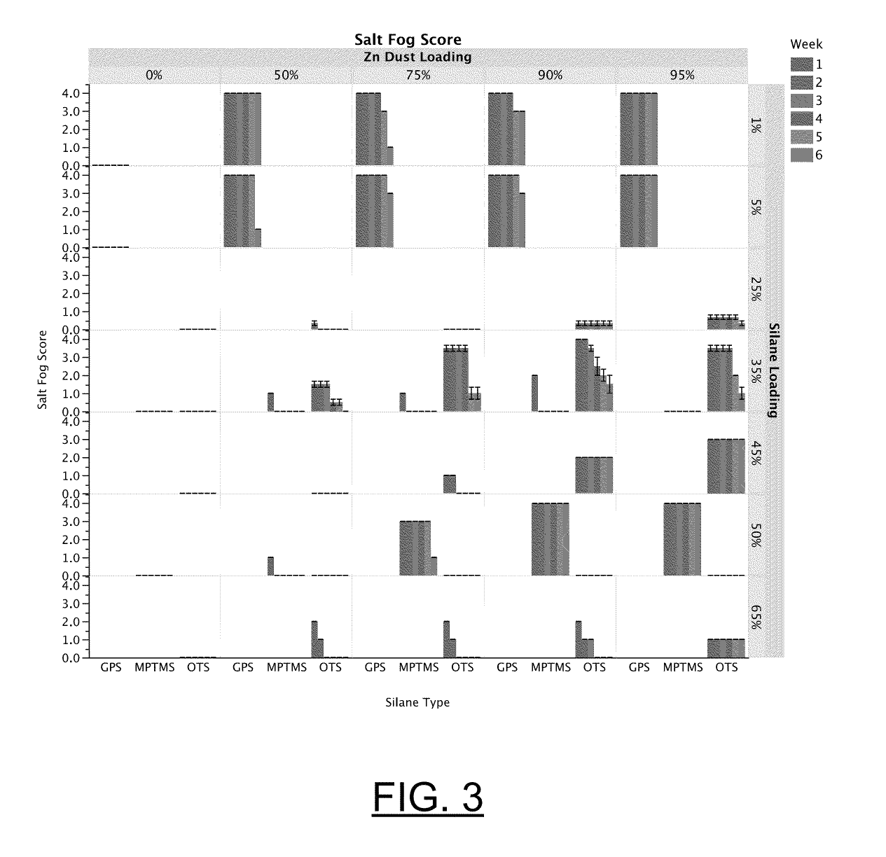

The results of the testing are set forth in FIG. 3.

The control sample with no zinc-rich primer began rusting almost immediately. The sample with zinc rich primer with an overcoat of CARC primer and CARC topcoat began rusting by week 2. The sample with zinc-rich primer only was rusted by week 3. A number of self-healing samples completed the entire 6-week trial with no rust. The best performing samples were 5% GPS (glycidoxypropyltrimethoxysilane), 50% MPTMS (methacryloxypropyltrimethoxysilane), and 45% OTS (octadecyltrimethoxysilane). Also notable was the 35% OTS sample, which was synthesized one year before testing, but still managed to be one of the best performers.

Generally speaking, 90-95% zinc dust loading was the best. This result is fortuitous, for these are the least expensive formulations. FIG. 5 provides a vivid illustration of the importance of including both self-healing and galvanic protection. Note how pure zinc-rich primer and pure microcapsule samples rusted heavily. The inclusion of only 5% (v/v) microcapsules in the coating was sufficient to delay the onset of rusting by at least a factor of 2 in this experiment.

FIG. 5 shows week-by-week rust scores for all six weeks of the salt fog test. The clear best performer was the 5% GPS followed closely by 1% GPS. Little to no rust was seen throughout the 5 weeks, and the strong performance was not greatly affected by the zinc dust loading. The 50% MPTMS sample performed well for 90-95% zinc loading, and, finally, the 45% OTS sample performed moderately well at 95% zinc loading.

In some embodiments, performance of a self-heating coating may be improved by the employment of microcapsules that include silane coupling agents (e.g., monosilane, silicane, silicon hydride, silicon tetrahydride, etc.). Silanes may be good adhesion promoters due to their ability to form covalent bonds with inorganic oxide layers and organic polymer films. Moreover, silanes exhibit good characteristics for forming a water repellant monolayer when released from the microcapsules due to a fissure, scratch or other disruption in the continuity of a self-healing coating. Silanes also cover a relatively large area with only a relatively small amount of material. Thus, the healing capabilities of a microcapsule that includes silane coupling agents may be increased.

In some embodiments, the silane coupling agents may be provided in a manner such that when microcapsules including, for example, polyurea and silane are ruptured due to a scratch or fissure, the silane may self assemble on a substrate (e.g., steel or other metallic materials) to repel salt and/or water. The self-assembly aspect may provide a self-healing coating material that is capable of forming a hydrophobic monolayer that protects the substrate without requiring any further manually initiated maintenance efforts.

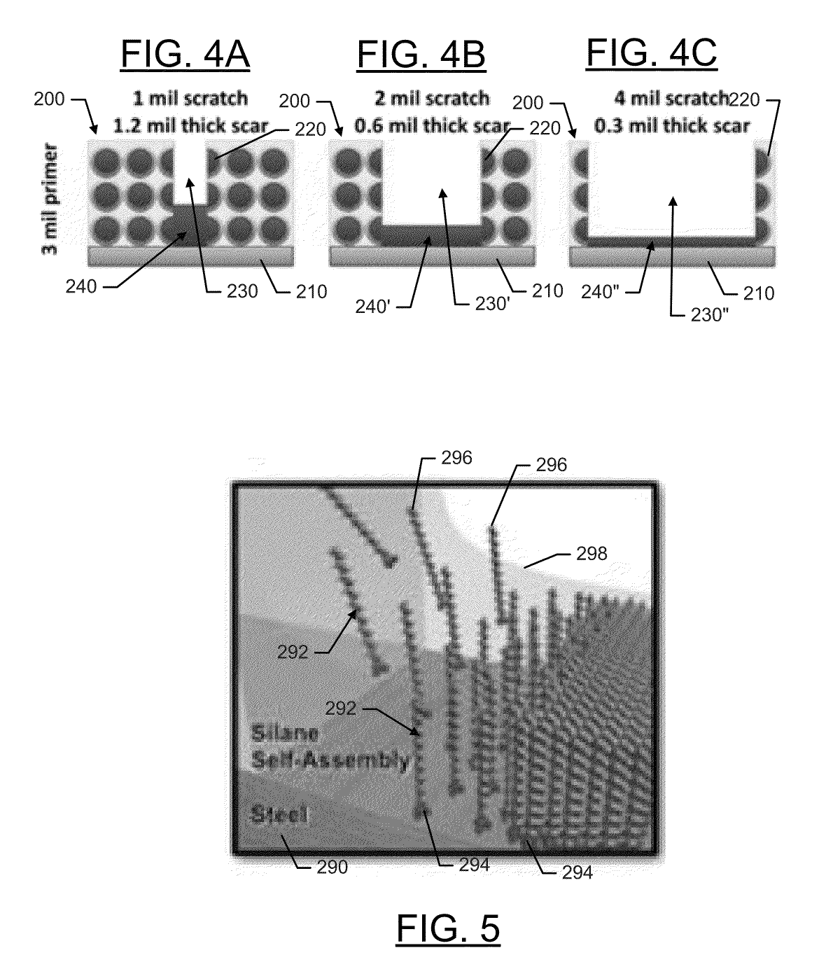

The utility of such a capability can be appreciated by referencing FIG. 4, which includes FIGS. 4A, 4B and 4C, and illustrates a cross section view of monolayer formation in fissures of varying sizes according to an example embodiment. In this regard, FIG. 4A illustrates a self-healing coating 200 that is about 3 millimeters thick and applied to a substrate 210 (e.g., steel). The self-healing coating 200 has a plurality of microcapsules 220 disposed in a closely packed crystal formation. The microcapsules 220 of an example embodiment may include silanes, as indicated above. A fissure 230 having a width of about 1 millimeter may be experienced in the self-healing coating 200 and has ruptured some of the adjacent microcapsules 220 as shown in FIG. 4A. The ruptured microcapsules 220 may release material to form a monolayer 240 proximate to the substrate 210 to protect the substrate 210 from corrosion. In this example, assume that the material released is sufficient to form the monolayer 240 to a thickness of about 1.2 millimeters.

The thickness of the monolayer 240 may be dependent upon the amount of material released by the ruptured microcapsules 220 and the size of the fissure 230. In this regard, as shown in FIG. 4B, if a fissure 230′ having double the size (i.e., 2 millimeters) is experienced, a thinner monolayer 240′ (e.g., 0.6 millimeters thick). Likewise, as shown in FIG. 4C, if a fissure 230″ having double the size (i.e., 4 millimeters) is experienced, a thinner monolayer 240″′ (e.g., 0.3 millimeters thick). Thus, it can be appreciated that the larger the area of the fissure, the thinner the coverage of the corresponding monolayer will be. The silane monolayer may have physical properties that are similar to paraffin wax when formed over a substrate. Thus, for example, the monolayer may require water molecules to incur a relatively large enthalpic penalty to traverse the monolayer and an even larger penalty for salts.

As mentioned above, silanes are useful for providing a large coverage area with a small amount of material. Accordingly, for example, silane may be useable to provide good protection of the substrate 210 even down to coatings in the nanometer range (e.g., around 1 nm or greater). In one example, a self-healing coating provided with 55% microcapsules by volume may be able to “heal” a 13 inch long scratch assuming only the microcapsules in the side walls release their resin (i.e., the worst case scenario). Thus, for example, the loading factor could be reduced by a significant amount (e.g., by a factor of 10) and reasonable sized scratches could still be healed relatively easily.

Because silanes are less disruptive toward emulsification and interfacial polymerization, using silane coupling agents within the microcapsules may provide relatively effective healing agents. In this regard, the silanes may promote crack wetting better than some other materials to provide for coverage of relatively wide cracks (e.g., 0.125 inches or greater). Silanes molecules also form a natural compatibilizer between resins (e.g., a polyurea resin) and steel since the silane head group bonds to steel and the organic tail bonds with polyurea. Surfactants, in contrast, may actually promote water-assisted crack growth by lowering the energy barrier for water penetration to the polyurea/metal interface. FIG. 5 shows an example of a monolayer being formed over steel 290 responsive to self-assembly of silanes 292. In this regard, the silane head 294 bonds to the steel 290 and the tail 296 bonds with polyurea resin to form the monolayer 298.

Silanes such as octadecyltrichlorosilane (OTS), which includes 18 methyl units attached to a silanol head group, has shown good protection against corrosion when employed in example embodiments. The OTS molecule spontaneously forms a self-assembled monolayer of molecules, with the silanol covalently attached to the substrate and the alkane tails forming a dense brush facing the air. Despite thicknesses in the nanometer range, the hydrophobic monolayer formed by OTS is very effective at preventing water and salt from crossing.

In some embodiments, further galvanic protection may also be provided by providing a zinc powder or dust, distributed together with the microcapsules in the coating. Moreover, the self-healing coating may be provided as a primer between the substrate and a topcoat of another layer of self-healing coating or some other paint or coating material. Accordingly, for example, some embodiments may provide microcapsules at about 55% loading within a primer material. However, in alternative embodiments, the loading may be decreased to significantly lower levels and a zinc-rich primer may be added without significantly reducing the degree of galvanic protection. 5% loading, for example, may be employed in a situation where the zinc network acts as a sacrificial anode without requiring the microcapsules to conduct electricity. Combined with a lower moisture sensitivity of silanes, embodiments with relatively lower degrees of loading may obviate any need for a metal shell all together. Foregoing a metal shell may eliminate many processing steps, remove palladium from some formulations to thereby decrease cost, and avoid environmental concerns associated with the use of nickel.

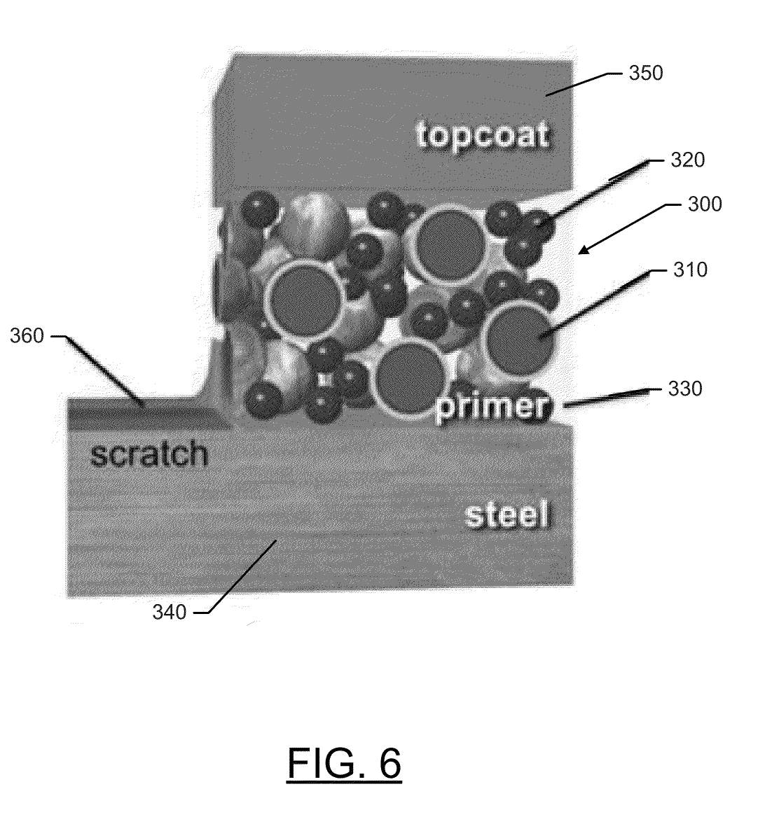

FIG. 6 illustrates a cross section view of a portion of a self-healing coating 300 according to another example embodiment. As shown in FIG. 6, the self-healing coating 300 may include microcapsules 310 (e.g., microcapsules with silane), zinc powder 320 and resin 330. The substrate 340, which may be steel in some examples, may be coated with the self-healing coating 300 and may also have a topcoat 350 disposed on top of the self-healing coating 300. Responsive to formation of a fissure, a self-assembled monolayer 360 may form proximate to the substrate 340 due to a flow of the material inside the microcapsules 310 that rupture into the fissure. The silane from the microcapsules 310 may form a water repellant and salt repellant layer in the form of the monolayer 360, but zinc powder 320 or dust may also form a portion of the monolayer 360 to cathodically protect the substrate 340. Thus, some example embodiments may provide self-healing in combination with galvanic protection. This may greatly extend the service life of coatings without requiring retraining or retooling. Maintenance requirements and corrosion costs may therefore be reduced for some equipment and operational readiness of the equipment may be improved.

The use of zinc powder in lieu of a Ni/Zn shell for microcapsules shifts the burden of providing galvanic protection away from the shell and to the zinc powder. Zinc depletion is therefore less likely to be problematic and thus a reversal of the polarization of steel to accelerate corrosion if zinc is depleted is also less likely. Individual microcapsules may also be electrically isolated by loading the microcapsules below the percolation threshold so that the likelihood of an anodic attack is reduced.

Example embodiments may therefore provide galvanic protection (via the zinc powder particles) while the silane from within the microcapsules sets up a monolayer to inhibit further corrosion of a substrate exposed by a fissure. Experimental data measuring changes in impedance responsive to scratching of a coating of an example embodiment suggests that self-healing to at least some degree may occur over any range of ratios of microcapsules (including silanes) to zinc powder. However, good performance is generally achieved at a ratio of 1:1 between microcapsules and zinc powder. Thus, two stages of protection are offered. In the first stage, immediately after the scratch occurs, the zinc powder provides cathodic protection to the substrate (e.g., steel) to inhibit corrosion. In the second stage, which may develop several minutes to several hours after the initial scratch, the monomer from the microcapsules that ruptured responsive to the initiation of the scratch polymerize and increase a resistance to the flow of corrosive ions to the surface of the substrate.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A microcapsule disposed in a self-healing coating including zinc powder particles dispersed therein along with the microcapsule, the microcapsule comprising at least a silane coupling agent encapsulated within a volume defined by one of a polymeric shell and a metallic shell that is rupturable responsive to formation of a fissure in the self-healing coating.

2. The microcapsule of claim 1, wherein the microcapsule comprises a sphere having an overall average diameter of from about 1 μm to about 120 μm.

3. The microcapsule of claim 1, wherein the silane coupling agent comprises octadecyltrichlorosilane (OTS).

4. The microcapsule of claim 1, wherein the microcapsule is disposed in a self-healing coating having a microcapsule loading of between about 5% and about 55%.

5. The microcapsule of claim 1, wherein the microcapsule is configured to rupture to release the silane coupling agent responsive to encountering a fissure in the self-healing coating, and wherein the zinc powder particles inhibit corrosion of a substrate onto which the self-healing coating composition is applied until a monolayer is formed by spreading of the silane coupling agent responsive to a fissure being formed in the self-healing coating to expose a portion of the substrate.

6. A self-healing coating composition comprising:
one or more film-forming binders;
a plurality of microcapsules, the microcapsules comprising at least a silane coupling agent encapsulated within a volume defined by one of a polymeric shell and a metallic shell that is rupturable responsive to formation of a fissure in the self-healing coating composition; and
zinc powder particles.

7. The self-healing coating composition of claim 6, wherein the microcapsules are disposed in a matrix including the zinc powder particles such that the zinc powder particles inhibit corrosion of a substrate onto which the self-healing coating composition is applied until a monolayer is formed by spreading of the silane coupling agent responsive to a fissure exposing a portion of the substrate and rupturing at least some of the microcapsules.

8. The self-healing coating composition of claim 6, wherein each of the microcapsules comprises a sphere having an overall average diameter of from about 1 μm to about 120 μm.

9. The self-healing coating composition of claim 6, wherein the silane coupling agent comprises octadecyltrichlorosilane (OTS).

10. The self-healing coating composition of claim 6, wherein loading of the microcapsules is between about 5% and about 55%.

11. The self-healing coating composition of claim 6, wherein the one or more film forming binders are selected from the group consisting of epoxy resins, polyester resins, polyurethane resins, polyvinylfluorodiene resins, alkyl resins, acrylic resins and nylon.

12. The self-healing coating composition of claim 6, wherein the one or more film forming binders comprise a paint primer selected from the group consisting of polyurethanes, oil-based enamels, enamel undercoaters, latex acrylics, acrylic formulations and epoxy formulations.

13. The self-healing coating composition of claim 6, wherein the one or more film forming binders form a topcoat selected from the group consisting of polyurethanes, oil-based enamels, enamels, latex acrylics, acrylic formulations and epoxy formulations.

14. A coated article comprising:
a metal substrate; and
a self-healing coating adjacent the substrate, the self-healing coating comprising:
a plurality of microcapsules, the microcapsules comprising at least a silane coupling agent encapsulated within a volume defined by one of a polymeric shell and a metallic shell that is rupturable responsive to formation of a fissure in the self-healing coating; and
zinc powder particles.

15. The coated article of claim 14, wherein the metal substrate comprises steel.

16. The coated article of claim 14, wherein the self-healing coating is a paint.

17. The coated article claim 16, wherein the paint is a paint primer selected from the group consisting of polyurethanes, oil-based enamels, enamel undercoaters, latex acrylics, acrylic formulations and epoxy formulations.

18. The coated article of claim 14, wherein the microcapsules are disposed in a matrix including the zinc powder particles such that the zinc powder particles inhibit corrosion of the metal substrate onto which the self-healing coating composition is applied until a monolayer is formed by spreading of the silane coupling agent responsive to a fissure exposing a portion of the metal substrate and rupturing at least some of the microcapsules.
